(19) United States
(12) Patent Application Publication
(10) Pub. No.: US 2006/0049099 A1
(43) Pub. Date: Mar. 9, 2006

(54) Filter device used in a paint cup of a spraying gun

(76) Inventor: Jen Chih Chang, Wurih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/933,276

(22) Filed: Sep. 3, 2004

(51) Int. Cl. B01D 35/01

(52) U.S. Cl. 210/472; 210/473; 210/477; 210/483; 210/497.3; 210/499

(57) ABSTRACT

A filter device used in a paint cup of a spraying gun, including a filter mounted in a paint cup body of the paint cup. The bottom of the paint cup body is tapered into a conic shape for connecting with a connecting tube for connecting with the spraying gun. An adjoining section between inner face of the conic bottom of the paint cup body and inner face of a wall of the paint cup body is formed as a fixing section for fixing the filter. The filter includes a plane filter mesh and a ventilating tube extending from one face of the filter mesh toward an opening of the paint cup body. The circumference of the filter mesh is engaged with the fixing section in the paint cup body. The ventilating tube has an internal passage passing through the filter mesh. An upper cap is fitted on one end of the ventilating tube, which end is distal from the filter mesh. The upper cap is formed with at least one ventage communicating with the passage of the ventilating tube and external side.

### BACKGROUND OF THE INVENTION

The present invention is related to a filter device used in a paint cup of a spraying gun, and more particularly to a filter device mounted in the paint cup of the spraying gun for filtering off the impurities entrained by the paint.

FIGS. 7 and 8 show the filter device of a conventional spraying gun. The filter device is composed of a cup body 6, a hollow bolt body 61 and a filter 62. The upper and lower ends of outer circumference of the bolt body 61 are formed with outer threads 611. A stop flange 612 is formed in the bottom of the bolt body 61 for stopping the filter 62. The filter 62 is a hollow column covered by a layer of filter mesh 621. Several ribs 622 are formed on outer circumference of the filter mesh 621, whereby a flow way is defined between the bolt body 61 and the filter mesh 621. The paint can flow through the flow way to filter through the filter mesh 621 and then flow into the spraying gun 64. Accordingly, the impurities entrained by the paint can be filtered off by the filter 62.

In the above structure, the filter 62 is wrapped by the filter mesh 621 and the ribs 622 are formed on outer circumference of the filter mesh 621. It is uneasy to manufacture such filter so that the manufacturing cost is relatively high. Moreover, the filter 62 has relatively small filtering area so that after a period of use, the impurities often jam the filter mesh 621. As a result, a user needs to frequently wash the filter mesh. Furthermore, the filter 62 has a complicated structure so that it is quite troublesome to install or detach the filter 62. It is necessary to first detach the cup body 6 and then takeout the filter 62 for washing. Therefore, it is time-consuming to remove the impurities accumulating on the filter 62.

FIG. 9 shows another type of filter of spraying gun. The filter 71 is mounted in the opening of the paint cup 7. The filter 71 has a cap 72. The top of the filter 71 is formed with an outer flange 711 for mounting the filter 71 on the opening of the paint cup 7. A filter mesh 713 is fixedly disposed in the bottom of the filter 71. An air conduit 712 is axially formed on inner wall of the filter 71. A lower end of the air conduit 712 extends through the filter mesh 713 to form an air passage. The paint filters through the filter mesh to flow into the paint cup 7 so that the impurities entrained by the paint is filtered off.

It is necessary to manufacture a cup mold for molding the cup-shaped filter 71. This leads to higher manufacturing cost. Furthermore, the air conduit 712 is free from any cover. Therefore, the paint is often incautiously poured into the air conduit 712 to jam the air conduit 712. Under such circumstance, the air conduit 712 will be sealed, making the paint unable to flow through the filter. In addition, the paint flowing through the air conduit 712 will directly flow into the paint cup 7 without filtering through the filter. Besides, the filter 71 is not engaged with the opening of the paint cup 7 so that the filter 71 tends to detach from the opening of the paint cup 7 in operation.

### SUMMARY OF THE INVENTION

It is therefore a primary object of the present invention to provide a filter device used in a paint cup of a spraying gun. The filter is disposed in the paint cup near the bottom thereof. The filter mesh of the filter is a plane mesh which provides larger filtering area so that the paint-filtering efficiency is enhanced. Also, the possibility of jam of the filter mesh due to the impurities entrained by the paint is reduced. The filter has simple structure and it is unnecessary to additionally design any fixing structure for fixing the filter mesh. Therefore, the manufacturing cost is relatively low and the competition of the product on market is enhanced.

It is a further object of the present invention to provide the above filter device in which the filter mesh has an upward extending ventilating tube and an upper cap fitted on top end of the ventilating tube. The upper cap of the ventilating tube is formed with several ventages which downward extend to outer side and communicate with the ventilating tube. By means of the upper cap, the jam of the ventilating tube due to impurities can be avoided and it can be ensured that no paint will be incautiously poured into the ventilating tube. Therefore, it can be avoided that the paint flows into the paint cup without being filtered.

It is still a further object of the present invention to provide the above filter device in which the ventilating tube extends to the opening of the paint cup for a user to easily taken out. Therefore, it is convenient to mount or detach the filter for washing the filter mesh. Therefore, the washing time of the filter mesh is shortened.

It is still a further object of the present invention to provide the above filter device in which the filter mesh of the filter is fixedly engaged with the bottom of the paint cup so that the filter is not easy to detach from the paint cup.

According to the above objects, the filter device of the present invention includes a filter mounted in a paint cup body of the paint cup. The bottom of the paint cup body is tapered into a conic shape for connecting with a connecting tube for connecting with the spraying gun. An adjoining section between inner face of the conic bottom of the paint cup body and inner face of a wall of the paint cup body is formed as a fixing section for fixing the filter. The filter includes a plane filter mesh and a ventilating tube extending from one face of the filter mesh toward an opening of the paint cup body. A circumference of the filter mesh is engaged with the fixing section in the paint cup body. The ventilating tube has an internal passage passing through the filter mesh. An upper cap is fitted on one end of the ventilating tube, which end is distal from the filter mesh. The upper cap is formed with at least one ventage communicating with the passage of the ventilating tube and external side.

The present invention can be best understood through the following description and accompanying drawings wherein:

### BRIEF DESCRIPTION OF THE DRAWINGS

FIG. 1 is a perspective assembled view of the present invention;

FIG. 2 is a sectional view of the filter of the present invention;

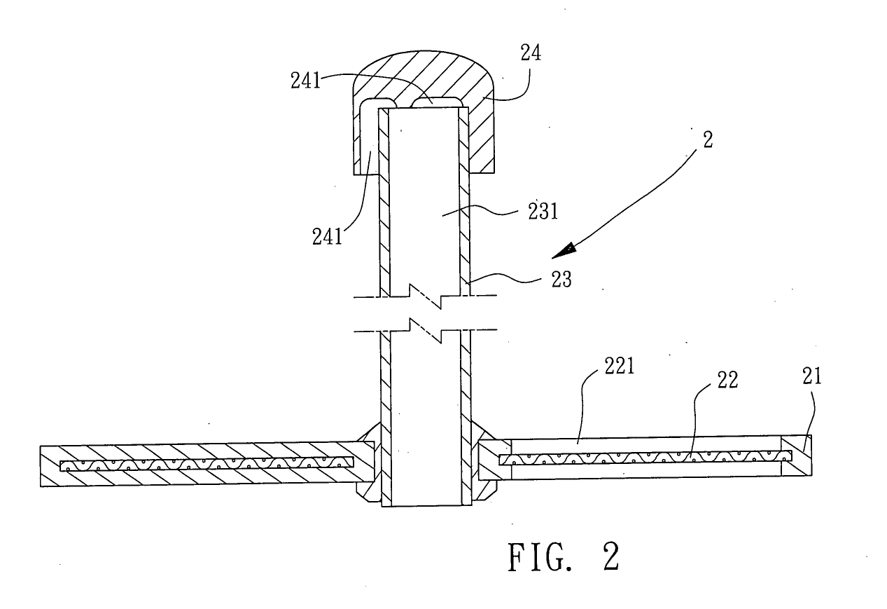

FIG. 3 shows the upper cap of the present invention;

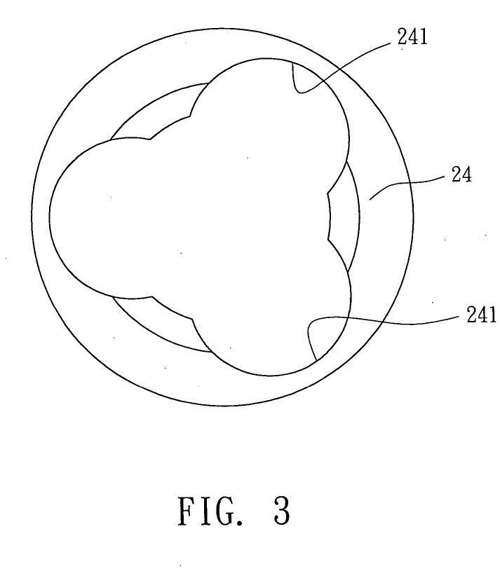

FIG. 4 is a sectional assembled view of the present invention;

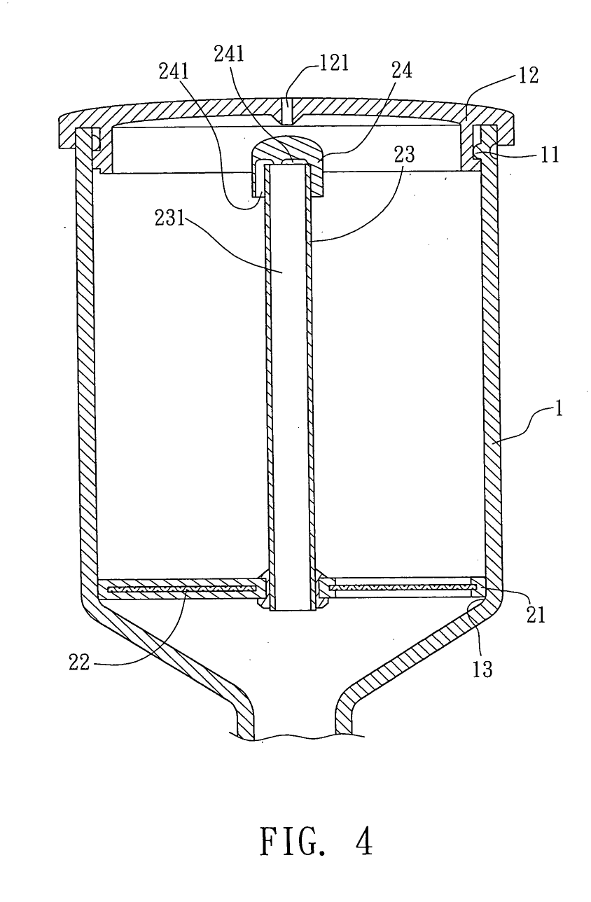

FIG. 5 is a sectional view according to FIG. 4, showing the use of the present invention;

FIG. 6 is a sectional view of a second embodiment of the filter of the present invention;

FIG. 7 is a perspective exploded view of a part of a conventional filter device;

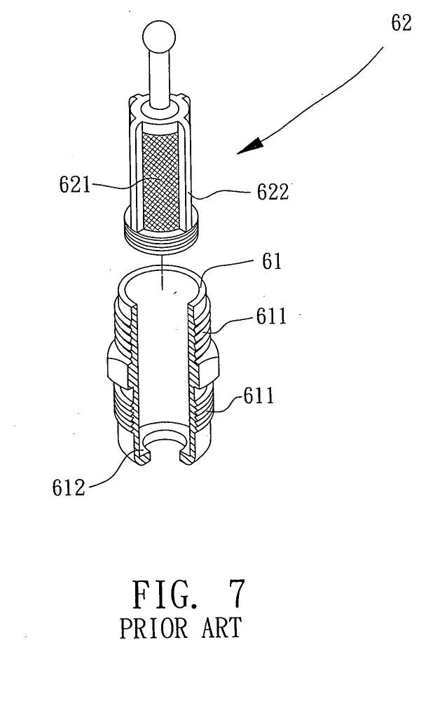

FIG. 8 is a sectional view showing that the filter device of FIG. 7 is mounted on a spraying gun; and

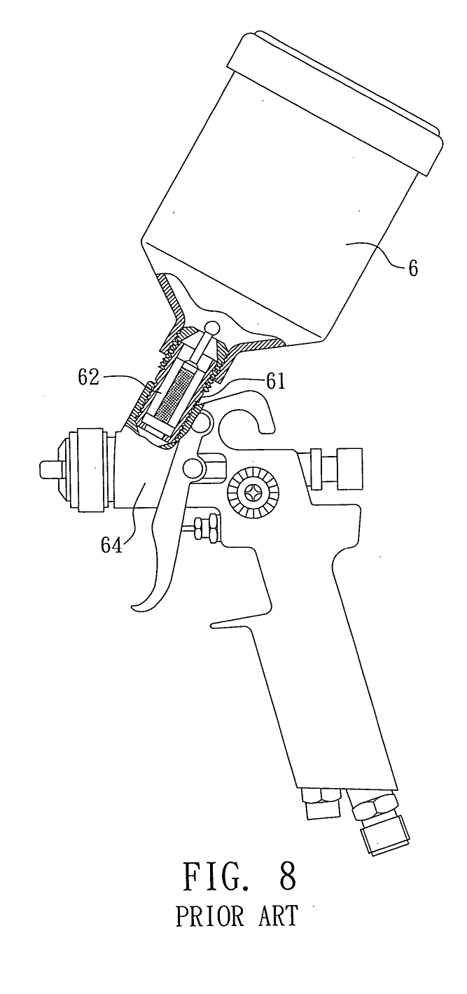

FIG. 9 is a perspective exploded view of another type of conventional filter device.

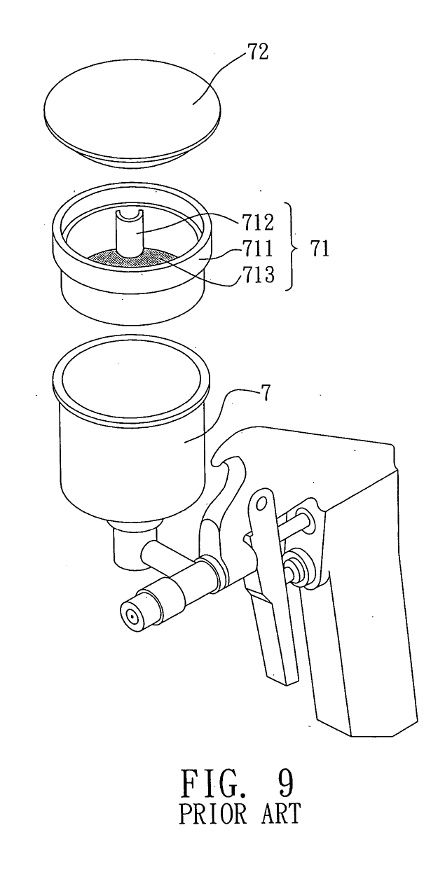

### DETAILED DESCRIPTION OF THE PREFERRED EMBODIMENTS

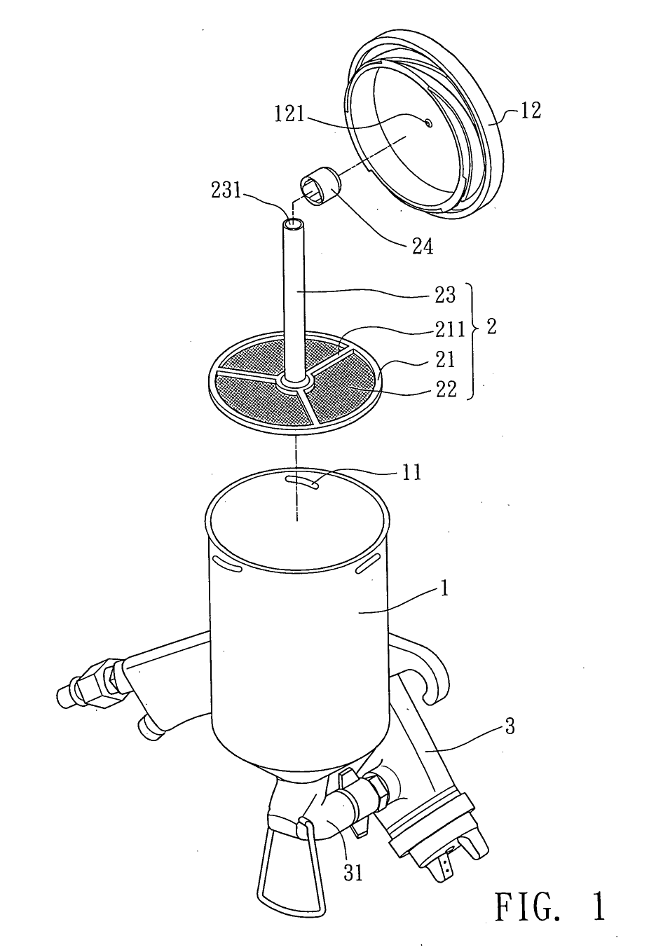

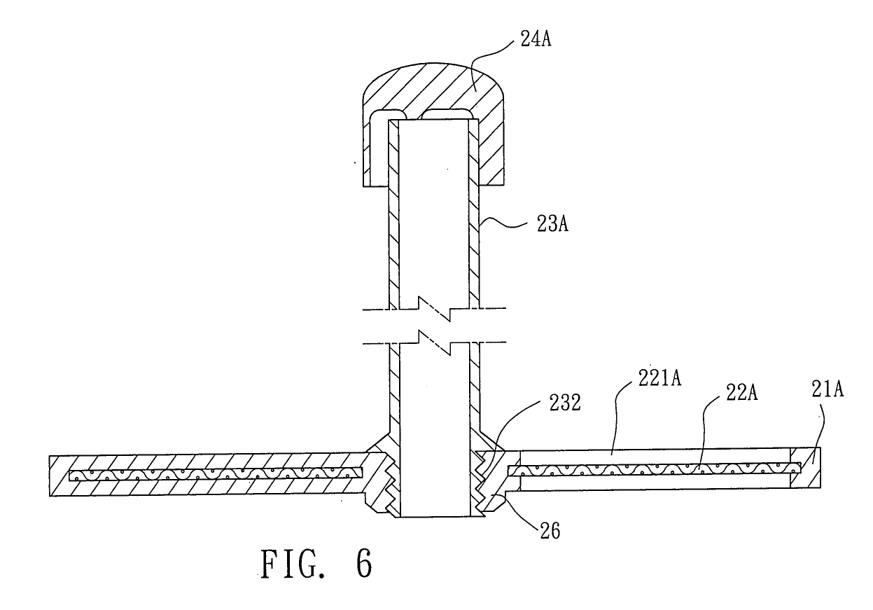

Please refer to FIGS. 1 and 6. The filter device used in the paint cup of the spraying gun of the present invention includes a filter 2 mounted in the paint cup body 1.

The opening of the paint cup body 1 is formed with several engaging sections 11 for engaging with a top cap 12 corresponding to the paint cup body 1. The top cap 12 is formed with a through hole 121. When the top cap 12 is mated with the paint cup body 1, the through hole 121 serves to remove the pressure in the paint cup body 1. The bottom of the paint cup body 1 is tapered into a conic shape for connecting with a connecting tube 31 for connecting with the spraying gun 3. An adjoining section between the inner face of the conic bottom of the paint cup body 1 and the inner face of the wall of the paint cup body 1 is formed as a fixing section 13 for fixing the filter 2.

The filter 2 includes a plane filter mesh 22 and a ventilating tube 23 extending from one face of the filter mesh 22 toward the opening of the paint cup body 1. The circumference of the filter mesh 22 is engaged with the fixing section 13 in the paint cup body 1. In this embodiment, the filter 2 further includes an annular frame section 21 for keeping the filter mesh 22 having its shape and supporting the upward extending ventilating tube 23. The annular frame section 21 surrounds the filter mesh 22. When the frame section 21 is molten and molded, the circumference of the filter mesh 22 is connected with the frame section 21. The frame section 21 has three reinforcing ribs 211 radially converging to the center of the frame section 21 for enhancing the strength of the frame section 21. By means of the support of the frame section 21, the filter mesh 22 can be fixedly engaged with the fixing section 13 of the paint cup body 1. The center of the frame section 21 is integrally connected with the ventilating tube 23 for supporting the ventilating tube 23 to upward extend to the opening of the paint cup body 1.

The ventilating tube 23 has an internal passage 231 passing through the filter mesh 22. An upper cap 24 is fitted on one end of the ventilating tube 23, which end is distal from the filter mesh 22. The upper cap 24 is formed with at least one ventage 241 communicating with the passage 231 of the ventilating tube 23 and external side. Accordingly, the passage 231 can be ventilated through the ventage 241. In this embodiment, the inner wall of the upper cap 24 is formed with three ventages 241 downward extending to outer side. The ventages 241 all communicate with the passage 231 of the ventilating tube 23.

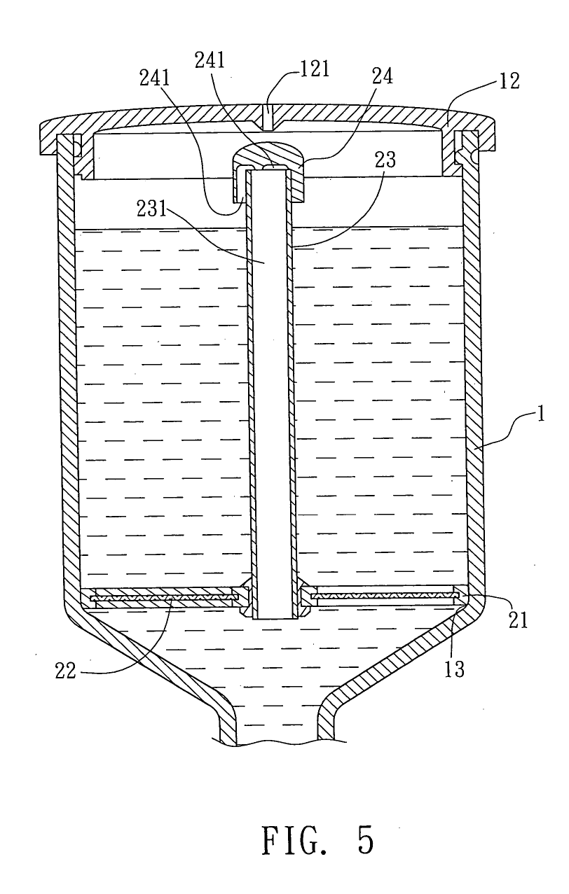

Referring to FIG. 5, when the paint is poured into the paint cup body 1, most of the impurities entrained by the paint are filtered off the filter mesh 22 of the filter 2. In addition, by means of the protection of the upper cap 24, the passage 231 of the ventilating tube 23 and the ventages 241 are kept free to achieve a ventilating effect. Accordingly, the paint cup body 1 is not sealed so that the paint in the paint cup body 1 can freely quickly flow through the filter mesh 22 into the spraying gun 3. Therefore, pure paint without any impurity can be evenly sprayed out.

When the filter device needs to wash, a user only needs to open the top cap 12 and quickly take out the filter 2 via the ventilating tube 23. It is no more necessary to detach other components for taking out the filter 2. Moreover, it is very easy to wash the plane filter mesh 22. After washed, the filter mesh 22 of the filter 2 is again fixed with the fixing section 13 of the paint cup body 1 via the ventilating tube 23. Such procedure is quite easy and convenient.

According to the above arrangement, the present invention has the following advantages:
1. The filter mesh of the filter is a plane mesh covering the entire inner face of the paint cup body. Therefore, the filter has larger filtering area so that the paint-filtering efficiency is enhanced. Also, the possibility of jam of the filter mesh due to the impurities entrained by the paint is reduced. Therefore, the number of times of washing the filter mesh is reduced.
2. The upper cap of the ventilating tube is formed with the ventages which downward extend to outer side. When implementing the paint, the paint will not be incautiously poured into the ventilating tube. Therefore, the jam of the ventilating tube due to impurities or not filtered paint can be avoided and it can be ensured that the ventilating tube is free for the air to flow through. Accordingly, the paint can quickly filter through the filter mesh.
3. The frame section can keep the shape of the filter mesh of the filter. In addition, the frame section is fixedly engaged with the fixing section of the conic bottom of the paint cup body. The existent paint cup bodies mostly have conic bottom sections so that the fixing section is naturally formed on the conic bottom. Therefore, it is unnecessary to additionally design any fixing structure for fixing the filter in the paint cup body. Furthermore, the filter has simple structure so that the manufacturing cost is greatly reduced and the competition of the product on market is enhanced.
4. The filter mesh of the filter is fixedly engaged with the bottom of the paint cup body so that the filter is not easy to detach in use.
5. The filter mesh of the filter is fixedly engaged with the bottom of the paint cup body and the ventilating tube extends to the opening of the paint cup body. Therefore, the height of the ventages of the upper cap is increased, whereby the capacity of the paint cup body is enlarged.

FIG. 6 shows a second embodiment of the present invention, in which the center to which the reinforcing ribs 211A of the frame section 21A of the filter mesh 22A are converged is formed with an inner thread section 26. One end of the ventilating tube 23A distal from the upper cap 24A is formed with an outer thread section 232 for screwing into the inner thread section 26 of the frame section 21A. Accordingly, the ventilating tube 23A can upward extend from the center of the filter mesh 22A. Similarly, the thread section 26 can be alternatively disposed on the circumference of the frame section 21A, whereby the ventilating tube 23 can upward extend from the circumference of the frame section 22A. Accordingly, the ventilating tube 23A is detachable from the filter mesh 22A to reduce volume. Therefore, the packing material can be reduced and the room for transfer can be also reduced.

The above embodiments are only used to illustrate the present invention, not intended to limit the scope thereof. Many modifications of the above embodiments can be made without departing from the spirit of the present invention.

What is claimed is:

1. A filter device used in a paint cup of a spraying gun, comprising a filter mounted in a paint cup body of the paint cup, a bottom of the paint cup body being tapered into a conic shape for connecting with a connecting tube for connecting with the spraying gun, an adjoining section between inner face of the conic bottom of the paint cup body and inner face of a wall of the paint cup body being formed as a fixing section for fixing the filter, the filter including a plane filter mesh and a ventilating tube extending from one face of the filter mesh toward an opening of the paint cup body, a circumference of the filter mesh being engaged with the fixing section in the paint cup body, the ventilating tube having an internal passage passing through the filter mesh, an upper cap being fitted on one end of the ventilating tube, which end is distal from the filter mesh, the upper cap being formed with at least one ventage communicating with the passage of the ventilating tube and external side.

2. The filter device used in the paint cup of the spraying gun as claimed in claim 1, wherein the opening of the paint cup body is formed with several engaging sections for engaging with a top cap corresponding to the paint cup body, the top cap being formed with a through hole, whereby when the top cap is mated with the paint cup body, the through hole serves to remove the pressure in the paint cup body.

3. The filter device used in the paint cup of the spraying gun as claimed in claim 1, wherein the filter further includes an annular frame section for keeping the filter mesh having its shape and supporting the upward extending ventilating tube, the annular frame section surrounding the filter mesh, whereby the filter mesh can be fixedly engaged with the fixing section of the paint cup body, the frame section having several reinforcing ribs radially converging to a center of the frame section, the ventilating tube being connected with the center of the frame section.

4. The filter device used in the paint cup of the spraying gun as claimed in claim 3, wherein one end of the ventilating tube is integrally connected with the center of the frame section.

5. The filter device used in the paint cup of the spraying gun as claimed in claim 3, wherein the center to which the reinforcing ribs of the frame section of the filter mesh converge is formed with an inner thread section, one end of the ventilating tube being formed with an outer thread section for screwing into the inner thread section of the frame section.

6. The filter device used in the paint cup of the spraying gun as claimed in claim 1, wherein inner wall of the upper cap is formed with three ventages downward extending to outer side, the ventages all communicating with the passage of the ventilating tube.
